(19) United States
(12) Patent Application Publication
(10) Pub. No.: US 2025/0376142 A1
(43) Pub. Date: Dec. 11, 2025

(54) ELECTROMECHANICAL BRAKE ACTUATOR FOR A VEHICLE BRAKE

(71) Applicant: ZF CV Systems Global GmbH, Bern (CH)

(72) Inventors: Jan Reiners, Hannover (DE); Peter Beler, Wunstorf (DE)

(21) Appl. No.: 19/230,352

(22) Filed: Jun. 6, 2025

(30) Foreign Application Priority Data
Jun. 6, 2024 (DE) 10 2024 115 788.7

(51) Int. Cl. B60T 13/74; B60T 17/22; F16D 55/226; F16D 65/18; F16D 66/00; F16D 121/24; F16D 125/28; F16D 125/40; F16D 125/68

(52) U.S. Cl. CPC B60T 13/746; B60T 17/22; F16D 55/226; F16D 65/18; F16D 66/00; F16D 2066/005; F16D 2121/24; F16D 2125/28; F16D 2125/40; F16D 2125/68

(57) ABSTRACT

An electromechanical brake actuator (10) for a brake of a vehicle (100) has a brake tappet (14) that can be moved substantially translationally for transmitting a compressive force (F) in the direction of a brake pad (6, 6′), a drive member (16) that generates a drive movement (A) and a coupling gear (18) that operatively connects the drive member (16) to the brake tappet (14). The coupling gear (18) converts the drive movement (A) of the drive member (16) into an adjustment movement (B) of the brake tappet (14). The coupling gear (18) has a coupling member (38) in contact with the brake tappet (14) that moves along a cam path (40, 60) and converts the substantially uniform drive movement into an adjustment movement (B) of the brake tappet (14) at, in portions, a non-uniform adjustment speed (B′).

### FIELD

The present disclosure relates to an electromechanical brake actuator for a brake of a vehicle, in particular for a commercial vehicle disc brake, having a brake tappet which can be moved substantially translationally for transmitting a compressive force in the direction of a brake pad, a drive member which is set up for this purpose, a drive member which is set up to generate a drive movement, preferably a rotatory drive movement, and a coupling gear which operatively connects the drive member and the brake tappet to one another and is set up to convert the drive movement of the drive member into an adjusting movement of the brake tappet.

Furthermore, the present disclosure relates to a disc brake for a vehicle, in particular a commercial vehicle disc brake, with a brake disc, a brake caliper, at least one brake pad movably mounted on the brake caliper for generating a braking effect by pressing against the brake disc, a pivotably mounted brake lever for pressing the at least one brake pad against the brake disc, and an electromagnetic brake actuator which is coupled to the brake caliper and is set up to effect an adjusting movement of the brake lever.

### BACKGROUND

Electromechanical brake actuators and brake systems with such brake actuators are being increasingly used instead of fluid-actuated brake systems in vehicle technology. The electrification of the brake systems in particular is intended to achieve energy savings and also simplify installation in the vehicle due to a smaller number of components or by minimizing the piping or dispensing with accumulators. To actuate such electromechanical brake systems, in particular to move a brake pad against a rotatable brake body to be decelerated, such as a brake disc, the known brake systems have an electromechanical brake actuator.

Known electromechanical brake actuators for a brake of a vehicle comprise at least one substantially translationally movable brake tappet for transmitting a compressive force in the direction of a brake pad, which moves against the rotating brake disc during operation of the vehicle. Furthermore, known electromechanical brake actuators include a drive member, by way of which a drive movement, preferably a rotational drive movement, is generated, and a coupling gear, which brings the drive member and the brake tappet into operative connection with each other. In addition, the coupling gear converts the drive movement of the drive member into the adjustment movement of the brake tappet.

The coupling gear thus converts the drive movement of the drive unit into the linear movement of the brake tappet required to actuate the brake caliper.

For example, electromechanical brake actuators for vehicle brakes are known from EP 3 622 194 B4 or WO 2017/220384 A1, which have coupling gears that have a non-linear transmission behavior between the drive movement generated by the drive member and the adjustment movement executed by the brake tappet. In particular, a uniform drive movement or a drive movement with a uniform drive speed is converted into an adjustment movement of the brake tappet with a varying adjustment speed. As a result, the brake tappet passes through areas along its adjustment path in which the brake tappet is moved faster, for example to bridge the clearance between the brake pad and brake disc, or slower, for example when the brake tappet reaches the end of its adjustment path.

The coupling gear disclosed in EP 3 622 194 B4 comprises a cam disc of which the outer circumferential surface is in contact with the brake tappet to transmit the drive movement and of which the rotation adjusts the brake tappet in the longitudinal direction. The predetermined outer contour of the cam disc produces a non-uniform adjustment movement of the brake tappet when it is rotated uniformly. A brake actuator designed in this way requires a comparatively large installation space in the wheel suspension area of a vehicle.

In WO 2017/220384 A1, a coupling gear is used, which comprises a ramp gear and a threaded gear, which have different transmission ratios and implement a non-linear transmission behavior and also convert a uniform drive movement into a non-uniform adjustment movement of the brake tappet. Such a coupling gear has a complex structure that requires full integration of the brake actuator into the brake caliper of the disc brake. However, the more compact design compared to EP 3 622 194 B1 does not allow any connection or combination with existing brake systems, which would necessitate a cost-intensive new development of such electromechanically actuated brake systems for each of the performance classes known to date.

### SUMMARY

In view of the above, the object of the present disclosure is to provide an electromechanical brake actuator which overcomes the disadvantages described above as far as possible. In particular, the object is to specify an electromechanical brake actuator which, in comparison to pneumatic brake actuators, requires a similarly small installation space and, in addition, can be combined with existing brake systems in a simple manner, at best without additional design effort, with simultaneously low component complexity and the lowest possible required drive power.

The present disclosure achieves the underlying object in an electromechanical brake actuator of the type described at the outset, wherein the coupling gear has a coupling member which is in contact with the brake tappet, is guided movably along at least one cam path, and is set up to convert a drive movement acting with a substantially uniform drive speed on the coupling member into movement of the brake tappet with, in portions, a non-uniform adjustment speed.

Preferably, the coupling gear thus has a non-linear transfer function between the drive movement of the drive member and the adjustment movement of the brake tappet, at least in portions. Preferably, the travel of the drive member is not proportional to the travel of the brake tappet, at least in portions. Preferably, the drive torque of the drive member is not proportional to the drive force of the brake tappet, at least in portions.

In the present case, the present disclosure makes use of the finding that the drive movement with its substantially uniform drive speed can be converted in a simple manner into an adjustment movement of the brake tappet with, in portions, a non-uniform adjustment speed by way of a coupling member on the coupling gear that is guided movably along a cam path. By way of the coupling member in contact with at least the brake tappet, a non-linear transmission element is formed in the coupling gear, which requires little installation space and enables the space-saving design of the electromechanical brake actuator. The coupling member, which is movably guided along at least one cam path, can be designed to save space in such a way that the electromechanical brake actuator according to the present disclosure is significantly more compact compared to the known brake actuators with non-linear transmission behavior and, in particular, does not require more installation space compared to a fluid-operated brake actuator. In addition, the proposed solution according to the present disclosure also allows the modular design of a brake system equipped with it, because the electromechanical brake actuator designed according to the present disclosure can in principle also be combined with conventional, previously fluid-actuated disc brakes.

The coupling gear therefore makes it possible to convert an actuating travel of the drive member, at least in portions, non-proportionally into the adjustment movement of the brake tappet. As a result, the application force that can be transmitted by the brake tappet is also, at least in portions, non-proportional to the actuating torque provided by the brake actuator. A non-linear coupling gear is therefore specified that enables low drive torques to be provided for the design of the drive member, wherein the coupling gear is so compact that it can be accommodated particularly well in the very limited installation space within the vehicle.

According to a preferred development of the present disclosure, it is provided that the cam path has several path portions, each of which defines different transmission ratios of the drive movement of the coupling member in the adjustment movement of the brake tappet. The cam path, which acts in particular as a guide path for the coupling member, is designed in such a way that when the coupling member is moved along the cam path, the brake tappet actuated by the coupling member is moved in portions at a speed which is increased or reduced compared to the drive speed, despite a substantially uniform drive movement of the coupling member itself. In particular, an air gap between the brake disc and a brake pad that can be brought into a frictional effect at the beginning of a braking process can thus be accelerated, i.e., passed in a shorter time. On the other hand, in a further, particularly downstream path portion, along which the application of greater adjustment forces to the brake tappet is required, an adjustment movement is implemented at a reduced speed compared to the upstream path portion.

In a preferred development, the coupling gear has a transmission ratio of the drive movement of the coupling member to the adjustment movement of the brake tappet along at least one path portion, which is less than 1. The path portion that defines a transmission ratio that is less than 1, i.e., translates the drive movement into a faster adjustment movement, forms in particular a first path portion of the cam path. Preferably, the first path portion is designed in such a way that the drive movement acting in the coupling area of the coupling member with the coupling gear is approximately doubled. The brake tappet is thus preferably moved twice as fast in the area of the first path portion as the part of the coupling member that is directly connected to the coupling gear coupled to it. According to one embodiment, the first path portion has a curved or curvilinear course. In particular, the clearance to be bridged at the start of a braking process is thus covered on the drive side with a comparatively short drive path of the coupling member.

In a possible development, the coupling gear has a transmission ratio along at least one path portion from the drive movement of the coupling member to the adjustment movement of the brake tappet, which is substantially equal to 1. The path portion that defines a transmission ratio that is approximately 1, i.e., does not change the speed of the drive movement to that of the adjustment movement, forms in particular a second path portion of the cam path designed as a guide path. The brake tappet is thus moved in the area of the second path portion at approximately the same speed as the entire coupling member, which is moved uniformly in portions by the coupling gear. The second path portion is particularly straight or has a straight course. When the coupling member is moved along the second path portion, it preferably retains an unchanged alignment or position relative to the second path portion.

In a possible further embodiment, the coupling gear also has a transmission ratio of the drive movement of the coupling member to the adjustment movement of the brake tappet along at least one path portion, which is greater than 1. With the aid of this path portion of the cam path, which in particular defines a third path portion of the cam path downstream of the second path portion, the drive movement acting on the coupling member is reduced so that the brake tappet, which is at least in contact with the coupling member, performs an adjustment movement at a lower, in particular continuously decreasing adjustment speed. The brake tappet is thus moved more slowly in the area of the third path portion, in particular continuously decelerated relative to the part of the coupling member that forms the drive-side connection point with the upstream part of the coupling gear. The decreasing adjustment speed of the brake tappet in this third portion of the path enables a reduction in the drive torque required to drive the coupling gear, particularly in the area of the maximum application force of the brake. An electromechanical brake actuator that has a coupling gear designed according to the present disclosure in this way can be equipped with a drive member that requires a reduced drive torque compared to brake actuators with a coupling gear with a linear transfer function, which further minimizes the costs for such a brake actuator according to the present disclosure.

According to a preferred development, the coupling member has a transmission element which is pivotably connected to the coupling gear along a portion of its direction of extension by way of a pivot bearing and is guided along the cam path at a predetermined distance from the pivot bearing. The provision of a transmission element on the coupling member enables a structurally simple design as a fixed connecting part between the brake tappet and the coupling gear and for implementing the non-linear transmission function by way of the coupling gear. Preferably, the transmission element of the coupling member, which preferably has the function of a lever rod, is moved by way of the coupling gear to perform the non-linear transmission behavior and, in addition, at least one portion of the coupling member performs a relative movement to the part of the coupling gear that moves the coupling member. As a result, two movements are superimposed on a portion of the transmission element opposite the guided portion in relation to the pivot bearing, wherein the non-linear transfer function is preferably realized on the electromechanical brake actuator. The multiple path portions of the cam path are preferably arranged adjacent to the path of movement of the coupling member implemented by way of the coupling gear. When the transmission element is moved, the coupling member is guided along the various path portions or is supported in a rolling manner along the path portions, with the transmission element of the coupling member changing its alignment in relation to the pivot bearing on the coupling gear during the movement of the coupling member.

According to a preferred embodiment, the coupling member is guided at one end along the cam path and coupled to the brake tappet at the opposite end. With the coupling member guided at one end and preferably coupled to the brake tappet at the opposite end, an immediate reaction takes place at the opposite end of the coupling member and in the adjustment movement of the brake tappet connected to it in conjunction with the pivoting mounting of the coupling member on the coupling gear in the event of a change in the guidance of the coupling member. Preferably, the first path portion for implementing a transmission ratio of less than 1 has a curved course which is arranged or designed in relation to the path of movement of the coupling member moved by the coupling gear in such a way that the end of the coupling member guided along the first path portion remains temporarily stationary when the drive movement is executed. A movement of the end of the coupling member guided in the cam path is only implemented when the coupling member transitions to the second path portion of the cam path, which converts a transmission ratio of approximately 1. In particular, the second path portion of the cam path runs parallel to the path of movement of the connection point to the coupling member, which is converted by way of the coupling gear. When the third path portion, which defines a transmission ratio greater than 1, is reached, a relative movement of the coupling member to the part of the coupling gear that moves the coupling member is again generated, which results in another change, in particular a reduction in the speed of the adjustment movement of the brake tappet. The third path portion can be straight or curved, wherein a third path portion, which is particularly straight, runs at an angle inclined to the path of movement formed by the coupling gear at the connection point for the coupling member.

Preferably, the coupling member is guided along a further cam path with its end coupled to the brake tappet. In addition to the cam path guiding one (first) end of the coupling member, a further, second cam path is provided, which guides the (second) end coupled to the brake tappet. The two cam paths can be used to absorb any forces acting on the coupling gear, in particular transverse to the path of movement of the coupling member. In particular, a torque arising due to the leverage effect acting on the coupling member or coupling gear can be counteracted by way of the two guide paths and such a torque can be safely diverted via both cam paths into a housing accommodating the coupling gear. Preferably, the second cam path assigned to the end on the brake tappet side is designed with its path portions corresponding to the “first” cam path or its path portions, so that unimpeded movement of the coupling member along both cam paths is achieved.

According to a preferred embodiment, the coupling gear is set up to perform a conversion from a rotational movement to a translational movement, preferably by way of a ball screw drive, which has a rotatably mounted threaded spindle and a threaded nut guided movably along the threaded spindle, wherein the coupling member is pivotably mounted on the threaded nut. The provision of a ball screw drive enables a structurally simple way of converting a rotary movement generated by the drive member into a translational movement. In addition, a ball screw drive, which preferably has a fixed threaded spindle in the axial direction and a threaded nut that moves in the axial direction of the threaded spindle, can be used to absorb high axial forces that arise when generating the drive movement acting on the coupling member. Instead of a threaded spindle that is fixed in the axial direction and a threaded nut that can move along the threaded spindle, a nut that is fixed in the axial direction but rotatable in itself and a threaded spindle that can move in the axial direction relative to the threaded nut can be used on a coupling gear, even if this is associated with a partially increased installation space requirement.

One possible development of the electromechanical brake actuator is that the drive member, preferably an electric motor, has an axis of rotation which is aligned parallel to the longitudinal axis of the threaded spindle, and wherein the drive member is coupled to the threaded spindle, preferably by way of several gears, such as spur gears, so that it can rotate. The parallel alignment of the axis of rotation of the electric motor to the axis of rotation of the threaded spindle ensures simple transmission of the drive movement in the direction of the coupling gear. The rotary movement generated by the drive member is preferably transmitted to the coupling gear by way of several spur gears. Preferably, a reduction gear is implemented by way of the spur gears connecting the drive member to the threaded spindle. A speed generated by the drive member is reduced in the direction of the output side, whereas the transmitted torque is increased. This means that cost-effective drive member, in particular cost-effective electric motors with low drive torques, can be used.

According to a preferred development of the present disclosure, it is provided that the drive member or the coupling gear is assigned a measuring device for detecting the actuator force generated by the drive member. This allows conclusions to be drawn about the braking force generated by the electromechanical brake actuator and transmitted in the direction of the brake pad. In particular, a defect occurring within the brake actuator can be easily detected with the aid of the actuator force measuring device, especially if the permissible drive torque generated by the drive member is detected before a predetermined adjustment movement of the brake tappet is reached.

According to one possible design, the brake tappet is preferably mounted so that it can move at an angle relative to its longitudinal axis in relation to the coupling gear. The inclination-adjustable mounting of the brake tappet, which is moved substantially translationally in the direction of a brake pad in order to transmit the compressive force, means that any deflection occurring at the end connected to the coupling member in the radial direction, i.e., transverse to the extension of the brake tappet, can be easily compensated for. The possible inclination adjustment of the brake tappet also ensures that the forces acting on the brake tappet can act directly in its longitudinal direction in particular. Preferably, the end of the brake tappet facing the coupling member and the coupling member are firmly connected to each other in the axial direction via a pivot bearing.

According to a second aspect, the present disclosure relates to a disc brake, in particular a commercial vehicle disc brake, with a brake disc, a brake caliper, at least one brake pad movably mounted on the brake caliper for generating a braking effect by pressing against the brake disc, a pivotably mounted brake lever for pressing the at least one brake pad against the brake disc and an electromechanical brake actuator which is coupled to the brake caliper and is set up to effect an adjusting movement of the brake lever.

The disc brake according to the present disclosure also achieves the object underlying the brake actuator according to the present disclosure, in that the electromechanical brake actuator is designed according to one of the preferred embodiments described above. A disc brake equipped with such a brake actuator according to the present disclosure can achieve a braking effect necessary for decelerating a vehicle in a simple and safe manner, wherein a reduced installation space is required to implement the solution according to the present disclosure by means of the non-linear transmission element on the brake actuator designed according to the present disclosure in addition to a rapid bridging of the air gap between the brake disc and a brake pad movable relative to the brake disc and an accelerated braking effect on the brake disc. Preferably, the brake actuator according to the present disclosure can be coupled to the mounts on the brake caliper of the disc brakes known from the prior art, which are otherwise actuated via a fluid drive. With such a disc brake according to the present disclosure, the modular structure of the various individual components that can be coupled to it is thus still guaranteed, which makes it possible to replace the previous fluidic actuator with the electromechanical actuator described in the present disclosure and also facilitates the repair of system components in the event of a defect.

According to a preferred embodiment of the disc brake, the brake tappet of the brake actuator is preferably coupled directly to the brake lever, which is movably mounted on the brake caliper. The compressive force generated by the brake actuator is thus transmitted directly between the brake tappet of the brake actuator and the brake lever, from which the compressive force is transmitted in the direction of the brake pad, which is also movably mounted on the brake caliper. In particular, the brake tappet and brake lever have directly corresponding contact surfaces, which are designed in such a way that a variable angle of inclination of the brake lever and brake tappet relative to each other can be compensated for via the contact surfaces.

According to a further aspect, the present disclosure relates to a vehicle, in particular a commercial vehicle, with a brake actuator according to one of the preferred embodiments described above or a disc brake according to one of the preferred embodiments described above.

The present disclosure according to the second and third aspects makes use of the same advantages as the electromechanical brake actuator according to the first aspect. Preferred embodiments or further embodiments of the first aspect are also preferred embodiments or further embodiments of the disc brake according to the second aspect and of the vehicle according to the third aspect and vice versa, which is why reference is made to the above explanations in order to avoid repetition in this respect.

### BRIEF DESCRIPTION OF THE DRAWINGS

The present disclosure is now described in more detail below by way of a preferred exemplary embodiment with reference to the attached figures, in which:

FIG. 1 is a sectional view of a disc brake according to the present disclosure with a brake actuator arranged thereon, shown in abstract form;

FIG. 2 is a schematic sectional view of the brake actuator from FIG. 1;

FIGS. 3a and 3b are representations that illustrate the operating principle of the coupling gear according to the present disclosure on the brake actuator, and

FIG. 4 is a schematic view of a vehicle with a disc brake according to the present disclosure.

### DETAILED DESCRIPTION

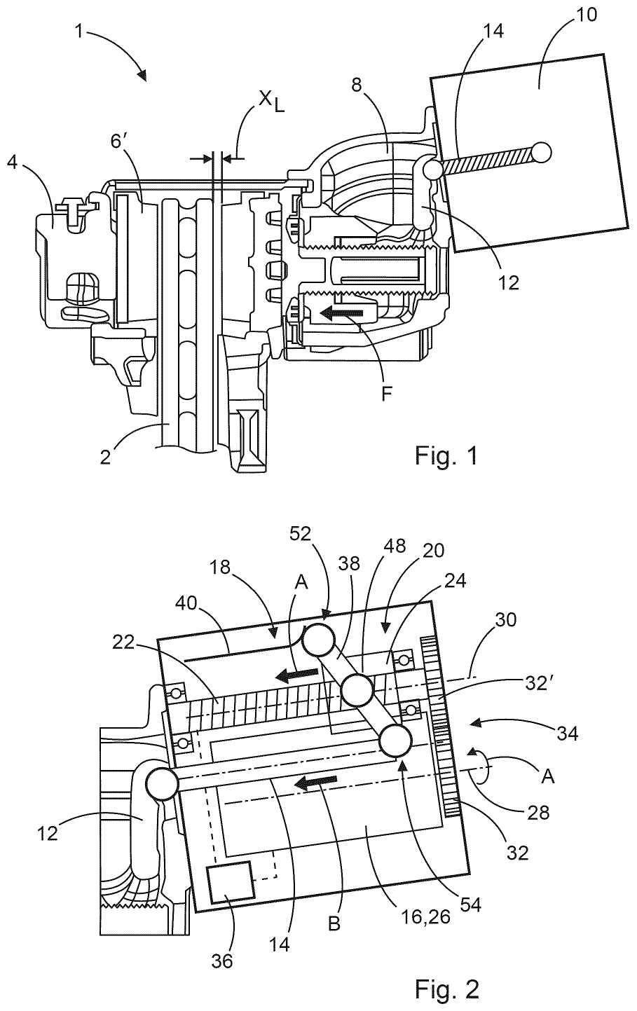

FIG. 1 shows a disc brake 1 for a vehicle 100 (shown in more detail in FIG. 4), in particular a commercial vehicle 102. The disc brake 1 includes a brake disc 2, which is mounted rotatably about an axis of rotation not shown in more detail. The disc brake 1 also has a brake caliper 4 and two brake pads 6, 6′ mounted on the brake caliper 4 on both sides of the brake disc 2 so that they can move relative to one another.

The disc brake 1 also includes a caliper carrier, not shown in detail, which is designed to accommodate the brake caliper 4 and to couple it in a fixed position to a rigid axle part of the vehicle 100, also not shown in detail. In the design shown here, the brake caliper 4 is designed to be movable relative to the caliper carrier. A coupling portion 8 for attaching an electromechanical brake actuator 10, shown schematically in FIG. 1, is also provided on the brake caliper 4.

The electromechanical brake actuator 10 interacts in particular with a pivotably mounted brake lever 12 for pressing the at least one brake pad 6, 6′ against the brake disc 2. The electromechanical brake actuator 10 includes at least one substantially translationally movable brake tappet 14 for transmitting a compressive force F in the direction of one of the brake pads 6, 6′.

FIG. 2 shows a schematic sectional view of the brake actuator 10 which, in addition to the brake tappet 14, also includes a drive member 16 which is set up to generate a drive movement A, preferably a rotational drive movement. In addition, the electromechanical brake actuator 10 has a coupling gear 18, which operatively connects the drive member 16 and the brake tappet 14 to one another. The coupling gear 18 is also set up to convert the drive movement A of the drive member 16 into a translational adjustment movement B of the brake tappet 14.

In the design shown here, the coupling gear 18 has a ball screw drive 20, which has a rotatably mounted threaded spindle 22 and a threaded nut 24 that is movably guided along the threaded spindle 22. The drive member 16, which is preferably designed as an electric motor 26, has an axis of rotation 28 which is aligned parallel to the longitudinal axis 30 of the threaded spindle. The drive member 16 is rotationally connected to the threaded spindle 22 in particular by way of a plurality of spur gears 32, 32′, which are part of a spur gearing 34.

In one possible embodiment, the electromechanical brake actuator 10 has a measuring device 36 for detecting the drive torque generated by the drive member 16 or the drive torque transmitted by the coupling gear 18.

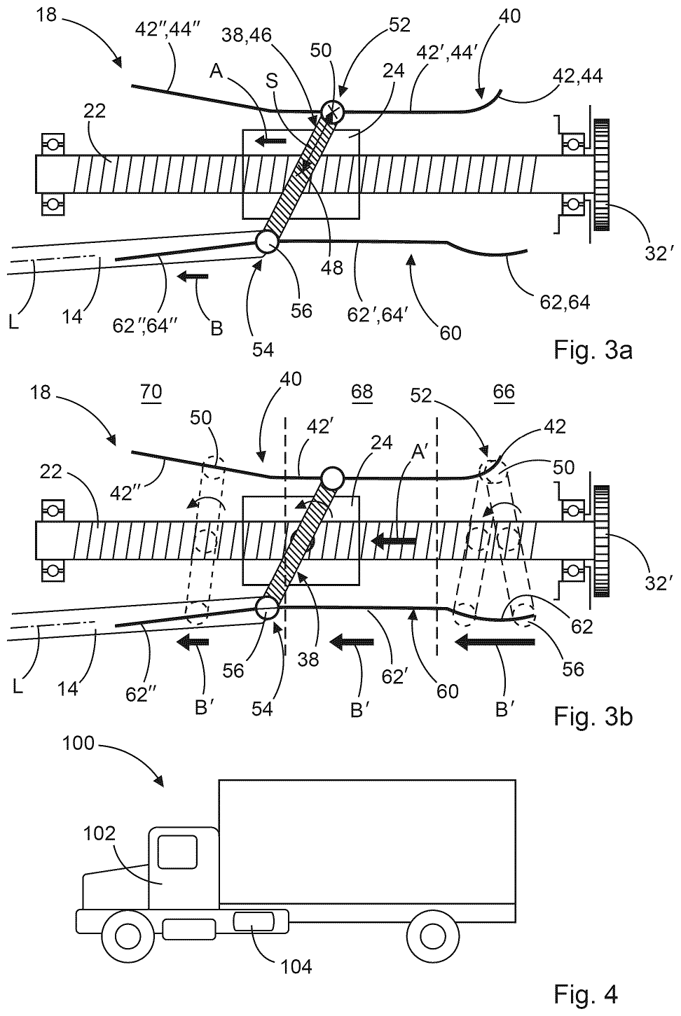

In the embodiment shown in FIG. 2, the coupling gear 18 has a coupling member 38 which is at least in contact with the brake tappet 14 and which is guided movably along at least one cam path 40. In particular, the coupling member 38 forms a non-linear transmission member on the brake actuator 10 within the coupling gear 18. The coupling member 38 is set up to convert a drive movement A acting on the coupling member 38 with a substantially uniform drive speed A′ (FIG. 3b) into the adjustment movement B of the brake tappet 14 with an adjustment speed B′ (FIG. 3b) that is uneven in portions.

As can also be seen from FIG. 2, the cam path 40 has several path portions 42, 42′, each of which defines different transmission ratios i of the drive movement of the coupling member in the adjustment movement of the brake tappet. One path portion, in particular a first path portion 42, has a curved course 44. Another, in particular a second path portion 42′, has a straight course 44.

FIGS. 3a and 3b illustrate the structure and, in particular, the operating principle of the coupling gear 18 according to the present disclosure with its coupling member 38, which converts a non-linear transfer function at the brake actuator 10 by way of the cam path 40. The coupling member 38 has a transmission element 46 which operates as a lever rod. The coupling member 38 is pivotably connected along a portion of its extent to the upstream part of the coupling gear 18, in particular the movably guided threaded nut 24, by way of a pivot bearing 48.

The coupling member 38 has a pivot point 50 at a predetermined distance s from the pivot bearing 48, which pivot point is set up for coupling with and guiding along the cam path 40. In the embodiment shown here, the pivot point 50 is arranged at a first end 52 of the coupling member 38, which is guided along the cam path. The coupling member 38 is coupled with its opposite, second end 54 to the brake tappet 14 by way of a second pivot point 56. In a further preferred embodiment, the brake actuator 10 has, in addition to the cam path 40, a further, second cam path 60, along which the second end 54 of the coupling member 38, which is coupled to the brake tappet 14, is guided by means of the second pivot point 56.

In the embodiment shown, the cam path 60 has several path portions 62, 62′, wherein the cam path 60 with its path portions 62, 62′ is designed to correspond to the first cam path 40 with its path portions 42, 42′ in such a way that the non-linear transfer function can be implemented. The path portion 62 also has a curved course 64 and the path portion 62′ has a straight course 64′. In particular, the path portions 42′ and 62′ of the cam path 40, 60 are arranged parallel to one another. As can be seen from the course of the second cam path 60, the brake tappet 14, in relation to its longitudinal axis L, is mounted so as to be movable in its inclination relative to the coupling gear 18.

FIG. 3b illustrates in detail the function of the coupling member 38 guided along the cam path(s) 40, 60. With their path portions, the cam path(s) 40, 60 divide(s) the movement of the coupling member 38 into three different movement portions 66, 68, 70. In the first movement portion 66, the coupling gear 18 along the first path portion 42 of the cam path 40 converts a transmission ratio i from the drive movement A of the coupling member 38 to the adjustment movement B of the brake tappet 14 of less than 1. This means that the drive movement A of the coupling member 38, which takes place by way of the threaded nut 24 guided along the threaded spindle 22, is converted into an adjustment movement B of the brake tappet 14 with a greater adjustment speed B′.

In the movement portion 68, the coupling member 38 converts a transmission ratio i of approximately 1 from the drive movement A of the coupling member 38 to the adjustment movement B of the brake tappet 14 along at least the second path portion 42′. This means that the drive movement of the coupling member 38 is converted into an adjustment movement B of the brake tappet 14 with an approximately equal adjustment speed B′.

To form the movement portion 70, the first and also the second cam path 40, 60 each have a further, third path portion 42″, 62″. The path portions 42″, 62″ also run in a straight line 44″, 64″, although they do not run parallel to each other, but at an angle to each other. As a result, the coupling member 38 converts a transmission ratio i of greater than 1 from the drive movement A of the coupling member 38 to the adjustment movement B of the brake tappet 14 along the third path portions 42″, 62″. Thus, in the movement portion 70, the drive movement A of the coupling member 38, which is uniform over the entire drive path or has a uniform drive speed A′, is converted into an adjustment movement B of the brake tappet 14 with a lower adjustment speed B′.

FIG. 4 shows a schematic representation of a motor vehicle 100, in particular a commercial vehicle 102. The motor vehicle 100 is equipped with a brake system 104, which has an embodiment of a disc brake 1 according to the present disclosure, shown in FIGS. 1 to 3b, with an electromechanical brake actuator 10 arranged thereon.

### Reference Signs (Part of the Description)

1 disc brake
2 brake disc
4 brake caliper
6,6′ brake pad
8 coupling portion
10 electromechanical brake actuator
12 brake lever
14 brake tappet
16 drive member
18 coupling gear
20 ball screw drive
22 threaded spindle
24 threaded nut
26 electric motor
28 axis of rotation
30 longitudinal axis
32, 32′ spur gear
34 spur gearing
36 measuring device
38 coupling member
40 cam path
42, 42′, 42″ path portion
44, 44′, 44″ course
46 transmission element
48 pivot bearing
50,56 pivot point
52 first end
54 second end
60 cam path
62, 62′, 62″ path portion
64, 64′, 64″ course
66, 68, 70 movement portion
100 vehicle
102 commercial vehicle
104 braking system
A, A′ drive movement/speed
B, B′ adjustment movement/speed
F compressive force
i transmission ratio
L longitudinal axis
S distance
XL air gap

What is claimed is:

1. An electromechanical brake actuator (10) for a vehicle disc brake (1) of a vehicle (100), the electromechanical brake actuator comprising:
a brake tappet (14) that moves substantially translationally and transmits a compressive force (F) in the direction of a brake pad (6, 6′),
a drive member (16) that generates a drive movement (A), and
a coupling gear (18) that operatively connects the drive member (16) and the brake tappet (14) to one another;
wherein the coupling gear (18) converts the drive movement (A) of the drive member (16) into an adjustment movement (B) of the brake tappet (14),
wherein the coupling gear (18) has a coupling member (38) which is in contact with the brake tappet (14),
wherein the coupling member (38) is guided movably along at least one cam path (40, 60) and converts the drive movement (A) of the drive member (16), which acts on the coupling member (38) at a substantially uniform drive speed (A′), into an adjustment movement (B) of the brake tappet (14) at an adjustment speed (B′) which is non-uniform in portions.

2. The electromechanical brake actuator as claimed in claim 1,
wherein the cam path (40) has multiple path portions (42, 42′, 42″), each of which define different transmission ratios of the drive movement (A) of the coupling member (38) into the adjustment movement (B) of the brake tappet (14).

3. The electromechanical brake actuator as claimed in claim 2,
wherein the coupling gear (18) has a transmission ratio (i) of the drive movement (A) of the coupling member (38) to the adjustment movement (B) of the brake tappet (14) along a first path portion of the path portions (42), which ratio is less than 1.

4. The electromechanical brake actuator as claimed in claim 3,
wherein the coupling gear (18) along a second path portion of the path portions (42′) has a transmission ratio (i) from the drive movement (A) of the coupling member (38) to the adjustment movement (B) of the brake tappet (14) which is substantially equal to 1.

5. The electromechanical brake actuator as claimed in claim 4,
wherein the coupling gear (18) along a third path portion of the path portions (42″) has a transmission ratio (i) of the drive movement (A) of the coupling member (38) to the adjustment movement (B) of the brake tappet (14) which is greater than 1.

6. The electromechanical brake actuator as claimed in claim 5, wherein the first path portion is curved, the second path portion is straight, and the third path portion is straight and arranged at an angle relative to the first path portion.

7. The electromechanical brake actuator as claimed in claim 1,
wherein the coupling member (38) has a transmission element (46),
wherein the coupling member (38) is pivotably connected to the coupling gear (18) along a portion of its extent by a pivot bearing (48), and
wherein the coupling member is guided along the cam path (40) at a predetermined distance from the pivot bearing (48).

8. The electromechanical brake actuator as claimed in claim 7,
wherein an orientation of the transmission element changes as the coupling member is guided along the cam path.

9. The electromechanical brake actuator as claimed in claim 1,
wherein the coupling member (38) has a first end (52) and second end (54) that is opposite the first end (52),
wherein the coupling member (38) is guided at the first end (52) along the cam path (40) and is coupled to the brake tappet (14) at the second end (54).

10. The electromechanical brake actuator as claimed in claim 9,
wherein the coupling member (38) is guided with the second end (54) coupled to the brake tappet (14) along a further cam path (60).

11. The electromechanical brake actuator as claimed in claim 10,
wherein the cam path and the second cam path each include a first path portion, a second path portion, and the third path portion,
wherein the first portions are curved, wherein the second end moves axially faster than the first end as the coupling member is guided along the first portions;
wherein the second path portions are straight and parallel to each other, wherein the first and second ends move at the same rate;
wherein the third path portions are straight and angled away from each other, wherein the second end moves axially slower than the first end.

12. The electromechanical brake actuator as claimed in claim 11,
wherein the brake tappet (14) moves more quickly as the coupling member is guided along the first portions relative to the second and third portions,
wherein the brake tappet (14) moves more slowly as the coupling member is guided along the third portions relative to the second and third portions,
wherein the brake tappet (14) moves at a constant rate as the coupling member is guided along the second portions.

13. The electromechanical brake actuator as claimed in claim 1,
wherein the coupling gear (18) performs a conversion from a rotational movement to a translational movement via a ball screw drive (20), which has a rotatably mounted threaded spindle (22) and a threaded nut (24) guided movably along the threaded spindle (22),
wherein the coupling member (38) is pivotably mounted on the threaded nut (24).

14. The electromechanical brake actuator as claimed in claim 13,
wherein the drive member (160 is an electric motor (26) and has an axis of rotation (28) that is aligned parallel to a longitudinal axis (30) of the threaded spindle (22), and
wherein the drive member (16) is rotationally coupled to the threaded spindle (22) by a plurality of gears (32, 32′).

15. The electromechanical brake actuator as claimed in claim 1,
wherein a measuring device (36) detects the tappet force generated by the drive member (16),
wherein the measuring device (36) is assigned to the drive member (16) or the coupling gear (18).

16. The electromechanical brake actuator as claimed in claim 1,
wherein the brake tappet (14), relative to its longitudinal axis (L), is mounted so as to be movable in its inclination relative to the coupling gear (18).

17. The electromechanical brake actuator as claimed in claim 1, wherein the drive movement (A) of the drive member (16) is a rotary drive movement.

18. A disc brake (1) comprising:
the electromagnetic brake actuator (10) according to claim 1,
a brake disc (2),
a brake caliper (4),
at least one brake pad (6, 6′) movably mounted on the brake caliper (4) that generates a braking effect by pressing against the brake disc (2),
a pivotably mounted brake lever (12) that presses the at least one brake pad (6, 6′) against the brake disc (2), and
wherein the electromagnetic brake actuator (10) is coupled to the brake caliper (4) and effects an adjustment movement of the brake lever (12).

19. The disc brake (100) as claimed in claim 18,
wherein the brake tappet (14) of the brake actuator (10) is directly coupled to the brake lever (12) that is movably mounted on the brake caliper (4).

20. A vehicle (100) comprising:
the disc brake (1) as claimed in claim 18.
